(19) United States
(12) Patent Application Publication
(10) Pub. No.: US 2006/0185207 A1
(43) Pub. Date: Aug. 24, 2006

(54) Illuminated ticket holder

(76) Inventor: Dave Mitcheltree, Dyer, IN (US)

Correspondence Address: WALLENSTEIN & WAGNER, LTD., 311 SOUTH WACKER DRIVE, 53RD FLOOR, CHICAGO, IL, 60606, US

(21) Appl. No.: 11/065,739

(22) Filed: Feb. 24, 2005

(51) Int. Cl. G09F 3/18

(52) U.S. Cl. 40/661

(57) ABSTRACT

An apparatus for the illuminated display of a printed article such as a sporting event or concert ticket includes a transparent ticket holder with a light source. The ticket holder has a first transparent layer of material with a peripheral edge. A second layer of material is bonded to the first transparent layer proximate to at least a portion of the peripheral edge to form a pocket. A slit provides repeatable access into the pocket. An illumination source receiver with a removable illumination source provides light with which to view the ticket in a darkened concert hall or arena. The ticket holder also has a suspension opening formed through at least one of the first or second layers of material allowing the ticket holder to be worn around a user's neck or wrist using a lanyard.

### TECHNICAL FIELD

The invention relates to a hands-free ticket holder such as for a concert or sporting event, and more particular to a ticket holder having an illumination source.

### BACKGROUND OF THE INVENTION

Holders designed for airline tickets, commuter tickets, personal identification badges and other articles are well known in the art. Generally, the holder includes an opening by which the ticket may be inserted into the holder. A portion of the holder is generally transparent so the ticket can be viewed without removing it. However, when no ambient light is present the ticket is not viewable. Additionally, the ticket holders of the prior art are limited because of the propensity of the ticket to fall out of the holder. While the ticket holders according to the prior art provide a number of advantageous features, they nevertheless have certain limitations.

The present invention is provided to overcome certain of these limitations and other drawbacks of the prior art, and to provide advantages and aspects not provided by prior ticket holders. A full discussion of the features and advantages of the present invention is deferred to the following detailed description, which proceeds with reference to the accompanying drawings.

### SUMMARY OF THE INVENTION

According to a first embodiment of the present invention, an apparatus for the display of a printed article such as a sporting event or concert ticket includes a transparent ticket holder. The ticket holder has a first transparent layer of material with a peripheral edge. A second layer of material is bonded to the first layer of material at, or near to, the peripheral edge to form a pocket. A slit in the first layer provides repeatable access into the pocket. A ridge along at least a portion of the slit assists in securing the ticket in place. An opening formed through one or both of the first and second layers of material allows the ticket holder to be hung from a lanyard.

According to another embodiment of the present invention, an apparatus for the illuminated display of a printed article such as a sporting event or concert ticket includes a transparent ticket holder with a light holder. The ticket holder has a first transparent layer of material with a peripheral edge. A second layer of material is bonded to the first layer proximate to at least a portion of the peripheral edge to form a pocket. A slit is formed in the first transparent layer and provides repeatable access into the pocket. The ticket holder also includes an illumination source receiver for holding an illumination source. A suspension opening is formed through at least one of the first or second layers of material and allows the ticket holder to be hung.

According to another embodiment of the present invention, an apparatus for the illuminated display of a printed article such as a sporting event or concert ticket includes a transparent ticket holder with a light source. The ticket holder has a first transparent layer of material with a peripheral edge. A second layer of material is bonded to the first transparent layer proximate to at least a portion of the peripheral edge to form a pocket. A slit provides repeatable access into the pocket. An illumination source receiver with a removable illumination source provides a light source to view the ticket in a dark concert hall or arena. The ticket holder also has a suspension opening formed through at least one of the first or second layers of material allowing the ticket holder to be worn around a users neck or wrist.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings. It should be understood, however, that the drawings are designed for the purpose of illustration only and not as a definition of the limits of the invention.

FIG. 1 is a front view of a ticket holder according to one embodiment of the present invention;

FIG. 2 is a perspective view of the ticket holder of FIG. 1 shown with a ticket being inserted;

FIG. 3 is a perspective view of the ticket holder of FIG. 1 shown with an illumination source being inserted and a fully seated ticket;

FIG. 4 is a front view of a ticket holder according to another embodiment of the present invention;

FIG. 5 is a front view of a ticket holder according to another embodiment of the present invention;

FIG. 6 is a front view of a ticket holder according to another embodiment of the present invention;

FIG. 7 is a front view of a ticket holder according to another embodiment of the present invention; and, FIG. 8 is a rear view of the ticket holder of FIG. 7.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

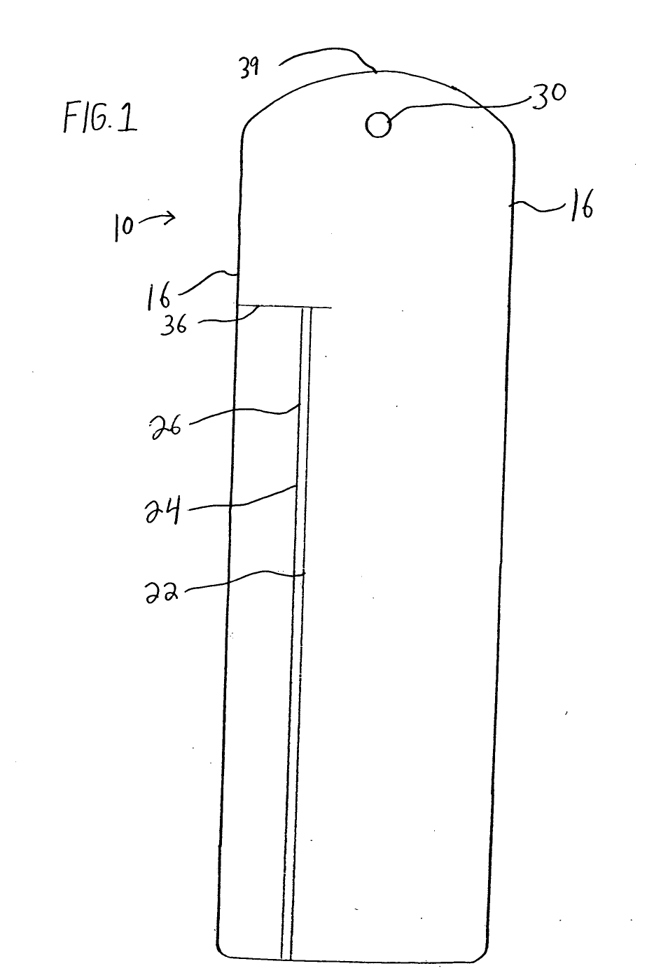

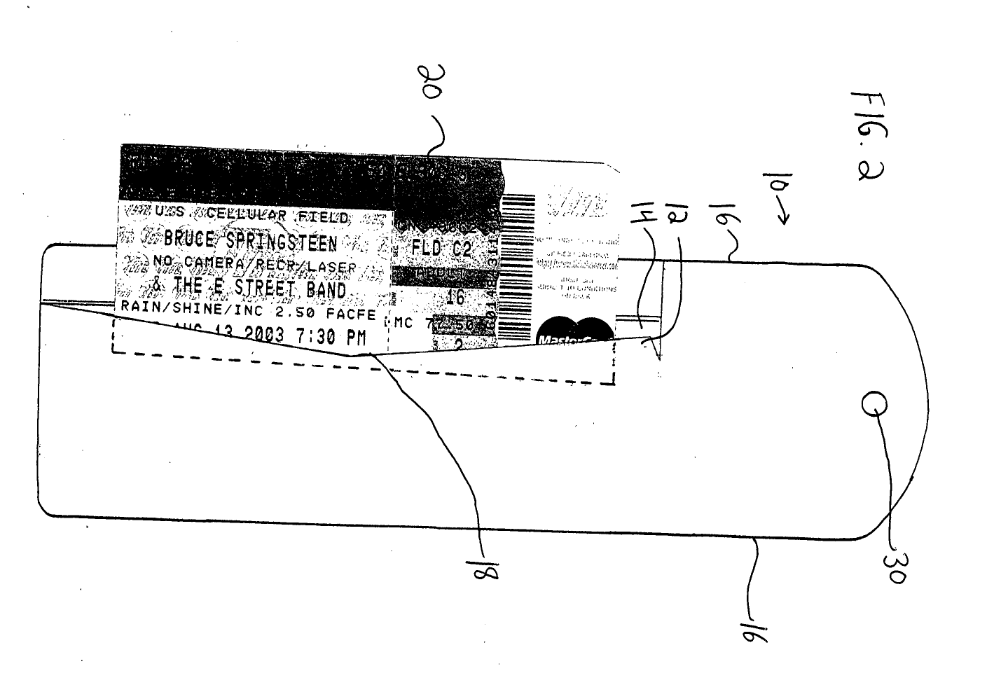

FIG. 1 shows a front view of a first embodiment of an apparatus for the illuminated display of a printed article, or a ticket holder 10. The ticket holder 10 is useful for holding articles such as a ticket to a sporting event, concert, or theatre production.

The ticket holder 10 is generally suitably dimensioned to hold a standard ticket measuring approximately five and one half inches by two inches without bending or folding of the ticket. However, it is appreciated that numerous other ticket holder sizes and shapes could be made in accordance with the principles of the present invention depending upon the size and shape of the ticket the holder is intended to display.

As shown in FIG. 2, the ticket holder 10 includes a first layer 12, generally of a transparent material. The first layer 12 is bonded to a second layer 14 proximate to and along a periphery 16 of the first layer 12. The material used for the second layer 14 is generally also transparent, and in some embodiments, the same material is used for both layers. The two layers are preferably bondable to one another using welding or adhesives. Numerous materials could easily be used to manufacture the invention, and are well known in the art. In the preferred embodiment, a transparent 8 gauge plastic is used. The preferred plastic is soft and flexible.

The bond between the first layer 12 and second layer 14 creates a pocket 18 into which a ticket 20 may be removably inserted as shown in FIG. 2. The pocket 18 is generally accessible through a slit 22 formed in the first layer 12. In other embodiments, the slit may be formed in the second layer, providing access to the pocket from the back of the ticket holder, or the slit may be formed between the two layers.

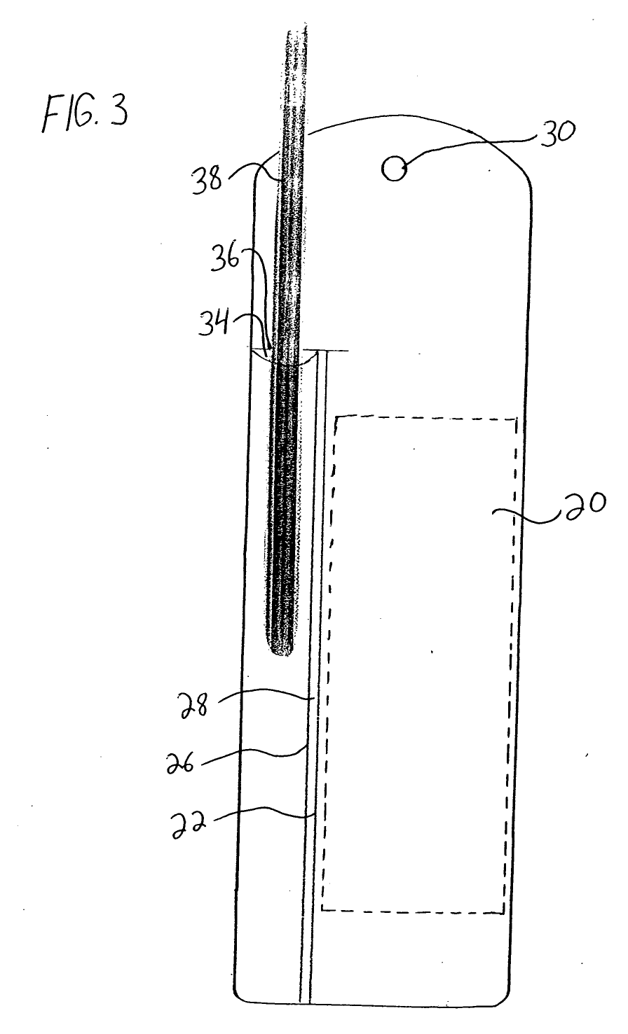

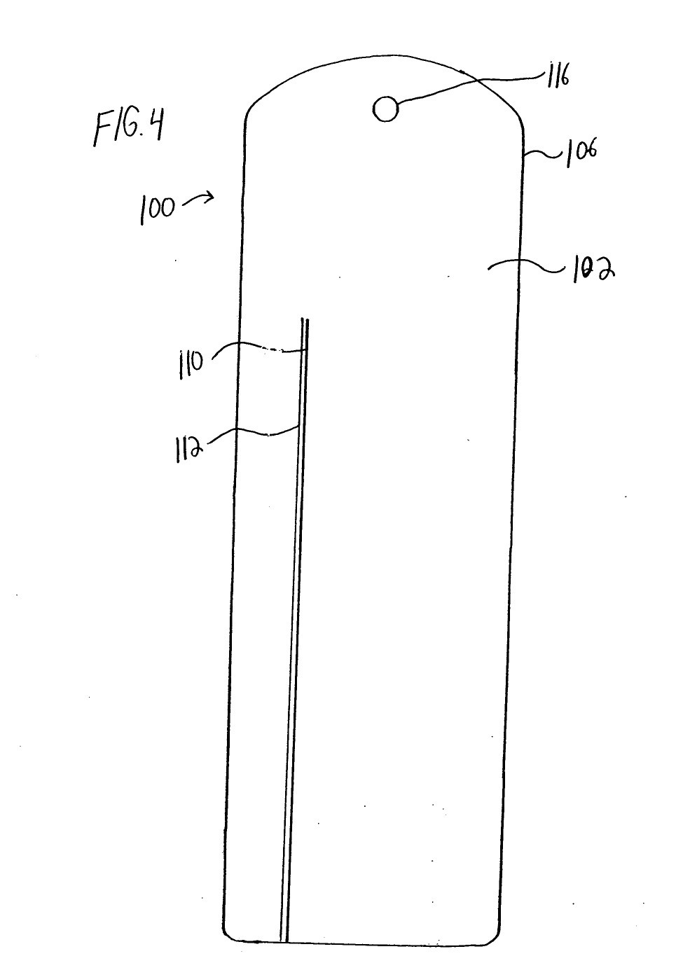

A ridge 24 is preferably located proximate to the slit 22. The ridge 24 functions as a stop that assists in holding the ticket 20 securely within the pocket 18. In the embodiment of FIGS. 1-3, the ridge is formed by a weld line 26 which extends along the slit 22 on the side opposite to where a fully seated ticket 20 is positioned (FIG. 3). In this embodiment, the ridge 24 also includes a narrow flap 28 of material from the first layer 12 which is present between the weld line 26 and the slit 22.

As shown in FIGS. 1-3 and 6, the ticket holder 10 also generally includes a suspension opening 30 formed through layers of material. The opening 30 provides a means for attaching a lanyard 32 to the ticket holder 10. The lanyard 32 is generally sized to fit either around a users neck or wrist. In this way, the ticket holder 10 can function in a hands-free manner, allowing the user full use of their hands for clapping or carrying other merchandise. The lanyard 32 preferably includes printed indicia 33 in the form of advertising.

The embodiment shown in FIGS. 1-3 includes an illumination source receiver 34. The illumination source receiver 34 is preferably a second pocket formed between the first layer 12 and second layer 14. In this embodiment, the second pocket is created by the weld line 26. The weld line 26 in this way serves dual purposes in both creating the second pocket and serving as a stop to assist in securing the ticket 20 in the first pocket 18. As shown in FIG. 3, the illumination source receiver 34 is accessible through a second slit 36. In FIG. 3, an illumination source 38 is being removably inserted into the illumination source receiver 34. Preferably, when the illumination source 38 is fully seated within the illumination source receiver 34, the entire illumination source 38 will be completely within the confines of the second pocket.

The illumination source 38 is preferably a chemiluminescent lightstick. Such chemiluminescent devices are well know in the art, and generally operate within a self-contained plastic shell by intermixing two or more chemicals upon demand to generate a glowing luminescence. Such chemiluminescent devices are commercially available from different suppliers including OmniGlow Inc. of Springfield, Mass.

The illumination source receiver 34 is generally positioned to maximize the utility of the light generated by the illumination source 38 to light up relevant portions of the ticket 20. For example, if the ticket 20 includes important information, such as the location of the seats for an event, the illumination source 38 is preferably positioned adjacent to that information. In addition, the ticket 20 and the illumination source 38 generally include length dimensions which are greater than their width dimensions. It is preferable to align the longer dimension of the ticket 20 with the longer dimension of the illumination source 38 to maximize the utility of any light generated by the illumination source 38.

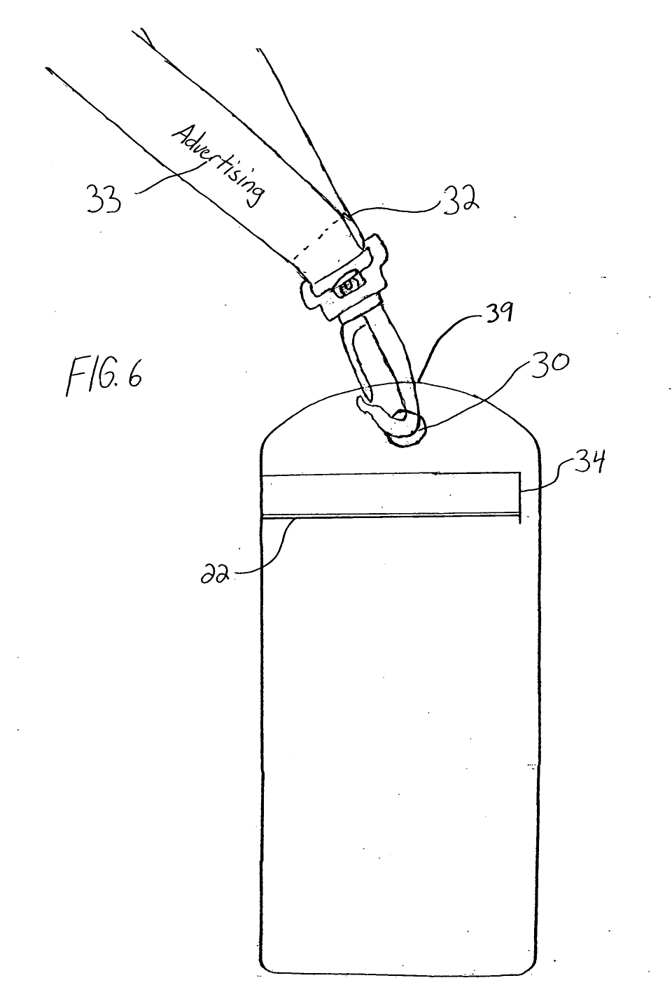

FIG. 6 is a front view of another embodiment of the present invention. The embodiment of FIG. 6 differs from the embodiment of FIGS. 1-3 in that the relative position of the slit 22, the illumination source receiver 34, and associated structure to the suspension opening 30 is different. In the embodiment of FIG. 6, the slit 22 is located adjacent to the suspension opening 30. Therefore, when the ticket holder 10 is suspended, the slit 22 and illumination source 38 would be located adjacent to a top 39 of the ticket holder 10.

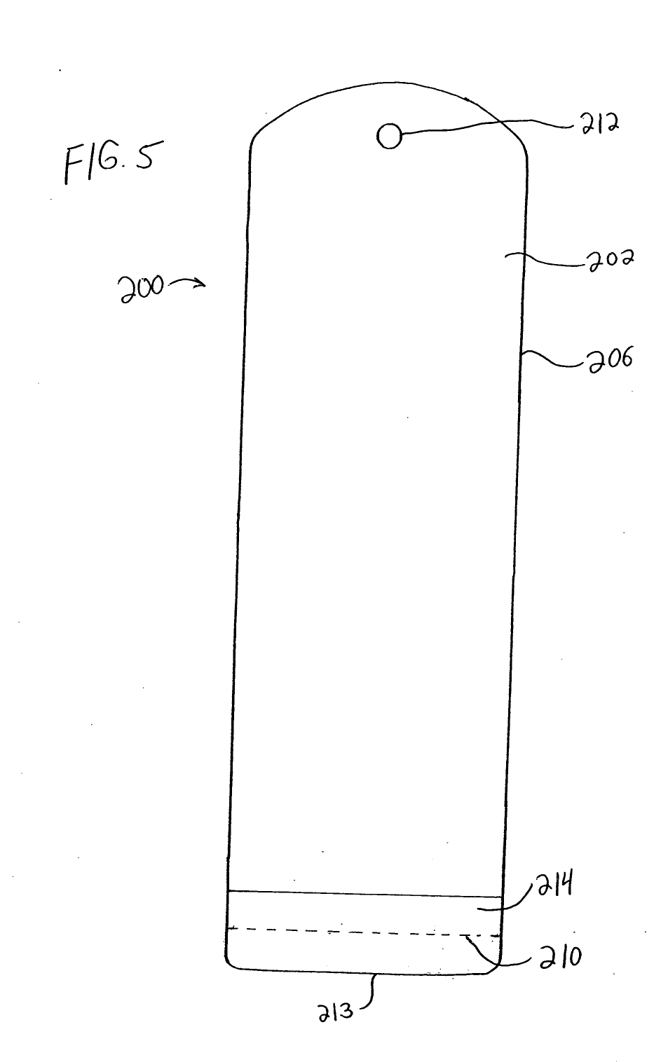

FIG. 4 is a front view of another embodiment of a ticket holder 100 according to the present invention. The ticket holder 100 of this embodiment again includes a first layer 102, generally of a transparent material. The first layer 102 is bonded to a second layer (not visible) proximate to a periphery 106 of the first layer 102. The two layers are preferably bondable to one another using welding or adhesives.

The bond between the first layer 102 and second layer 104 creates a pocket into which a ticket may be removably inserted. The pocket is generally accessible through a slit 110 formed in the first layer 102.

A ridge 112 is located proximate to the slit 104. The ridge 112 functions as a stop that assists in holding the ticket securely within the pocket. The ridge 112 here is a raised protrusion of material.

The ticket holder 100 as shown in FIG. 4 also includes a suspension opening 116 formed through the layers of material. The opening 116 provides a means for attaching a lanyard to the ticket holder 100.

An illumination source may optionally be removably inserted into the pocket. Once in the pocket, the illumination source is movable throughout the pocket. In this manner, the user can direct any light provided by the illumination source to whichever portion of the ticket they desire.

FIG. 5 is a front view of another embodiment of a ticket holder 200 according to the present invention. The ticket holder 200 of this embodiment again includes a first layer 202, of a transparent material bonded to a second layer (not visible) proximate to a periphery 206 of the first layer 202.

A pocket is created between the first layer 202 and the second layer which is accessible through a slit 210 formed in the first layer 202.

The ticket holder 200 as shown in FIG. 5 also includes a suspension opening 212 formed through the layers of material. The suspension opening 212 provides a means for attaching a lanyard to the ticket holder 200.

In the embodiment of FIG. 5, the slit 210 is positioned opposite to the suspension opening 212 of the ticket holder 200. When the ticket holder 200 is suspended, the slit 210 is positioned near a bottom edge 213 of the ticket holder 200. In order to prevent a ticket held within the ticket holder 200 from falling out during use, a ridge 214 comprising a flap of material extends from the bottom edge 213 over the slit 210.

The arrangement of FIG. 5 is useful in preventing any damage from occurring to a ticket within the ticket holder 200 due to inadvertent spillage of beverages during use, and is particularly suited for protecting souvenir type tickets.

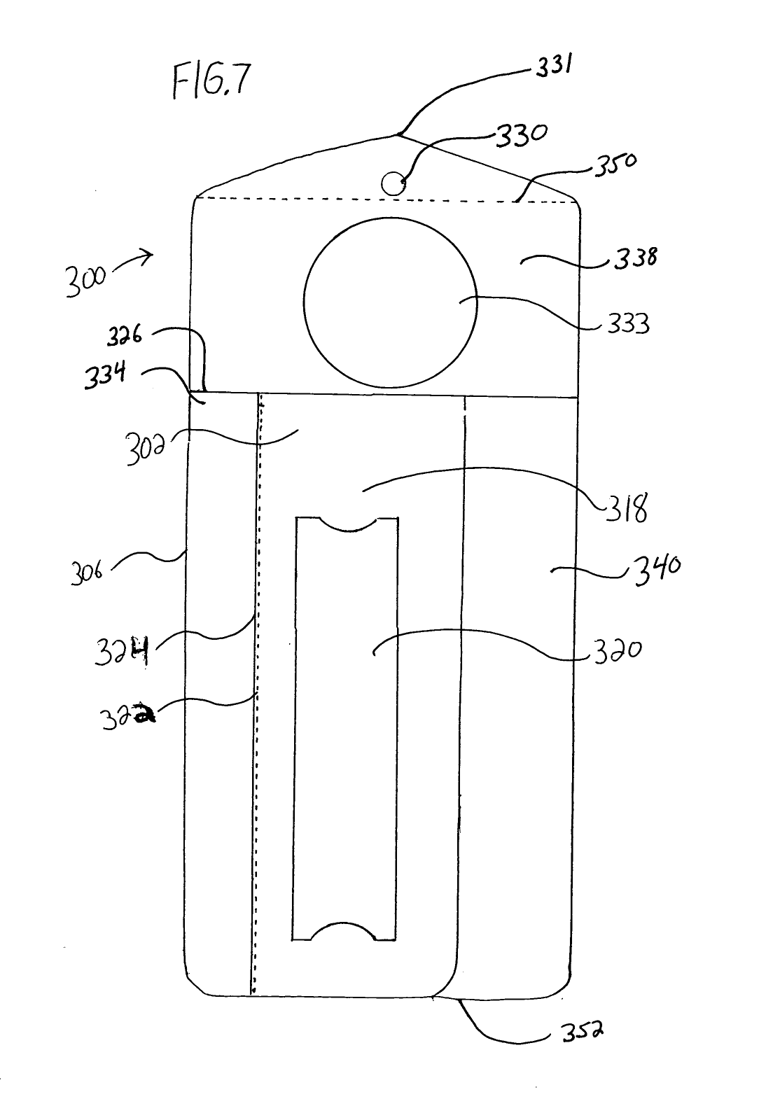

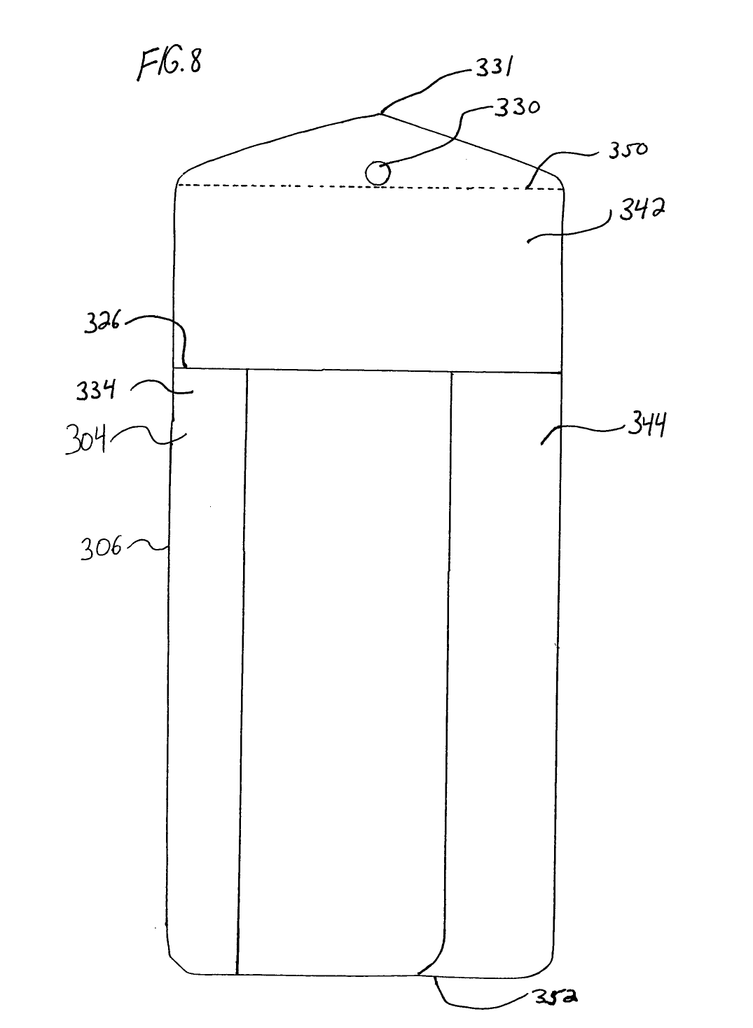

FIG. 7 is a front view of another embodiment of a ticket holder 300 according to the present invention. The ticket holder 300 of this embodiment again includes a first layer 302, of a transparent material bonded to a second layer 304, shown in the rear view of FIG. 8. The first layer 302 and second layer 304 are heat-seal welded to one another along a portion of the periphery 306 of the first layer 302. Additional, heat-seal welds are strategically placed to form a pocket 318 into which a ticket 320 may be removably inserted. The material of the first layer is clear to provide a clear view of the ticket 320 when it is positioned in the pocket 318.

The pocket 318 is generally accessible through a slit 322 formed in the first layer 312. A weld line 324 is preferably located proximate to the slit 322. The weld line 324 forms a ridge that assists in keeping the ticket inside the pocket 318.

As shown in FIGS. 7 and 8, the ticket holder 300 includes a suspension opening 330 formed near to a top 331 of the ticket holder 300. The opening 330 provides a means for attaching a lanyard to the ticket holder 300.

The embodiment shown in FIGS. 7 and 8 includes an illumination source receiver 334. The illumination source receiver 334 is preferably a second pocket formed between the first layer 312 and second layer 314. In this embodiment, the top of the second pocket is defined by a horizontal weld line 326. The illumination source receiver 334 is accessible through a second slit along the weld line 326.

The embodiment of FIGS. 7 and 8 also include advertising panels. Numerous advertising panels are utilized in this embodiment. The advertising panels are generally printed or pasted with a sticker or other advertising. In some embodiments, the advertising panels may comprise a second material different from the transparent material of the first layer 312. In yet another embodiment, the advertising panels may be removable along a perforated edge. A first advertising panel 338 is on the front of the ticket holder 300 adjacent to the first pocket 318 along the top 331 of the ticket holder 300. A second advertising panel 340 is also adjacent to the first pocket 318 on the front of the ticket holder 300. Additional advertising panels 342 and 344 are located on the back of ticket holder 300 as shown in FIG. 8. The advertising panels are preferably segmented from the each other and from the pockets via an additional weld line 346.

An alternative or additional illumination source may be provided for use in some embodiments. As shown in FIG. 7, the alternative or additional illumination source is preferably an illuminating wafer or button 333 attached to the first advertising panel 338, or to another location on the first layer 312. Such illuminating stick or button 333 can include an adhesive surface that may be removably adhered to the first layer 312. Such stick on wafers or buttons are commercially available from different suppliers including OmniGlow Inc. of Springfield, Mass. In an alternative embodiment, an additional pocket sized to accept a circular illuminating source may be provided as an alternative to the “stick on” button. The light stick and/or light button can have indicia thereon. When lit, the illuminating material within the stick and/or button will cause the indicia to be is visible in a light deprived environment, such as in a concert hall after the lights are turned out. The illumination material will allow for the indicia to be visible for at least a period of time during which the chemicals cause the stick and/or button to be lit. The indicia can be a source identifier, such as a trademark or service mark (name of a product, company, etc.), for advertising and/or marketing a product and/or a service connected to such source identifier.

The length of the embodiment shown in FIGS. 7 and 8 as measured from a horizontal line 350 tangent to the suspension opening 330 to a bottom edge 352 is preferably about eight inches. The horizontal weld line 326 is preferably located two inches below the top horizontal line 350. Therefore, the pockets for holding the ticket and the illumination source are preferably about six inches in length.

The total width of the embodiment shown in FIGS. 7 and 8 is preferably about three and one-half inches. The illumination source receiver 334 is preferably one inch wide. The pocket 318 for holding the ticket 320 is preferably about one and seven-eighths inches wide. The illumination source used in conjunction with this embodiment is preferably about five and three-quarters inches in length.

While the specific embodiments have been illustrated and described, numerous modifications come to mind without significantly departing from the spirit of the invention, and the scope of protection is only limited by the scope of the accompanying claims.

What is claimed is:

1. An apparatus for the display of a printed article comprising:
a first transparent layer of material having a peripheral edge;
a second layer of material bonded to said first transparent layer proximate to at least a portion of said peripheral edge to form a pocket;
a slit in said first transparent layer providing repeatable access into said pocket;
a ridge along at least a portion of the slit; and,
a suspension opening formed through at least one of the first or second layers of material from which the apparatus may be hung.

2. The apparatus of claim 1 wherein the ridge extends along the entire length the slit.

3. The apparatus of claim 1 further comprising an illumination source receiver formed between the first and second layers of material and a second slit providing repeatable access into said illumination source receiver.

4. The apparatus of claim 1 wherein the second layer of material is transparent.

5. The apparatus of claim 3 further comprising an illumination source removably positioned within said illumination source receiver.

6. The apparatus of claim 5 wherein the illumination source is a chemiluminescent lightstick.

7. The apparatus of claim 1 further comprising a removable lanyard fastened to said suspension opening.

8. The apparatus of claim 1 further comprising an illumination source operably connected to the first layer.

9. An apparatus for the illuminated display of a printed article comprising:
a first transparent layer of material having a peripheral edge;
a second layer of material bonded to said first transparent layer proximate to at least a portion of said peripheral edge to form a pocket;
a slit in said first transparent layer providing repeatable access into said pocket; and,
an illumination source receiver;
a suspension opening formed through at least one of the first or second layers of material from which the apparatus may be hung.

10. The apparatus of claim 9 wherein the illumination source receiver is a second pocket formed between the first and second layers of material.

11. The apparatus of claim 10 wherein the second pocket is separated from the first pocket by a weld line.

12. The apparatus of claim 9 further comprising an illumination source removably positioned within said illumination source receiver.

13. The apparatus of claim 12 wherein the illumination source is a chemiluminescent lightstick.

14. The apparatus of claim 9 further comprising a removable lanyard fastened to said suspension opening.

15. The apparatus of claim 7 wherein the removable lanyard includes printed indicia.

16. An apparatus for the illuminated display of a printed article comprising:
a first transparent layer of material having a peripheral edge;
a second layer of material bonded to said first transparent layer proximate to at least a portion of said peripheral edge to form a pocket;
a slit providing repeatable access into said pocket; and,
an illumination source receiver having a removable illumination source positioned therein;
a suspension opening formed through at least one of the first or second layers of material from which the apparatus may be suspended.

17. The apparatus of claim 16 wherein the illumination source is a lightstick and/or an light button.

18. The apparatus of claim 17 wherein he light stick and/or light button has indicia thereon, the indicia being visible in a light deprived environment for at least a period of time.

19. The apparatus of claim 18 wherein the indicia is a source identifier for advertising and/or marketing a product and/or a service.

20. The apparatus of claim 16 wherein the suspension opening is formed through the first and second layers of material.
